(19) United States
(12) Patent Application Publication
(10) Pub. No.: US 2021/0059461 A1
(43) Pub. Date: Mar. 4, 2021

(54) IMPROVEMENTS IN AND RELATING TO A COOKING APPARATUS

(71) Applicants: Michael Francis, Bristol (GB); Suzanna Mellersh, Bristol (GB)

(72) Inventors: Michael Francis, Bristol (GB); Suzanna Mellersh, Bristol (GB)

(21) Appl. No.: 16/958,645

(22) PCT Filed: Jun. 26, 2018
(86) PCT No.: PCT/GB2018/051777

§ 371 Date: Jun. 26, 2020

(30) Foreign Application Priority Data
Dec. 28, 2017 (GB) 1722034.4

(51) Int. Cl. A47J 27/05; A47J 36/20; B65D 81/34

(52) U.S. Cl. CPC A47J 27/05; A47J 2027/043; B65D 81/3438; A47J 36/20

(57) ABSTRACT

Improvements in and relating to a cooking apparatus A container (201) for storing and steaming food is disclosed, together with a packaged food product, a method of packaging food items and a method of cooking food items. The container (201) comprises a first compartment (202) for containing a steam source and a second compartment (203) for containing at least one food item. The second compartment (203) is disposed above the first compartment (202). Preferably, the first compartment (202) is separated from the second compartment (203) by a partition (221) and an adjustable barrier (240), the partition (201) comprising at least one opening (223) for admitting water vapour into the second compartment (203) from the first compartment (202). Preferably, the adjustable barrier (240) is movable from a) a food storing configuration in which the adjustable barrier (240) prevents flow of at least one of i) liquid and ii) gas from the first compartment (202) to the second compartment (203), to b) a food steaming configuration in which at least one of i) liquid and ii) gas is able to flow between the first and second compartments (202, 203).

### FIELD OF THE INVENTION

The present invention relates to apparatus for cooking, in particular for cooking through steaming; more particularly but not exclusively apparatus suitable for cooking in a microwave.

### BACKGROUND OF THE INVENTION

Increasing convenience in foodstuffs and foodstuff preparation is common across many societies, as well as a contemporaneous great recognition of the importance of good food. This can create a difficult conflict needing an effective solution.

More particularly, there is an increasing demand for foodstuffs that offer a high level of convenience, while also remaining nutritious and enjoyable for the consumer. Pre-prepared, packaged foods have been available for many years, often as ready-to-eat items intended for immediate consumption without any cooking. However, many consumers prefer hot (rather than cold) ready-to-eat food products. As an alternative to such cold foods, ready-to-eat hot food has traditionally been provided by take-away food vendors. However, such vendors can be limiting on consumers flexibility both in terms of when they consume a food product and where. Furthermore, hot take-away food products are often considered by consumers to be a less healthy, less nutritious food choice. Microwavable meals have provided consumers with another flexible and convenient food option, since they can be prepare quickly and simply at any time provided that the consumer has access to a microwave. However, microwave cooking can give some foods unappetising textures.

One cooking method that is particularly effective in preserving the nutritional value of foodstuffs is steam cooking. In steam cooking, foodstuffs are cooked by contact with hot steam. Typically, a steam cooker comprises various interconnected compartments, including at least a first compartment for holding water and a second for holding food. When the water in the first compartment is boiled, its steam passed through to the second compartment, cooking the food. It will be appreciated that the steam should be able to quickly and easily pass between the compartments for the cooking to be effective. While such cooking methods are well known, they are difficult to utilise in the ready-to-cook food market, not least because premature contact between the food product and water/water vapour can lead to deterioration of the food product.

US 2014 348 989 (Resurreccion et al) discloses a package for heating a food product, comprising paperboard material and a microwave energy interactive material. The package comprises a first container with a first sidewall and a first bottom wall, the first sidewall and the first bottom wall cooperating to form a first interior space; a second container received in the interior space of the first container. The second container has a second sidewall and a second bottom wall forming a second interior space comprising a portion of the first interior space. The second bottom wall is spaced apart from the first bottom wall to define a first compartment below the second bottom wall for receiving a first product and a second compartment above the second bottom wall for receiving a second product, wherein the second bottom wall has at least one vent opening for allowing steam to pass from the first compartment to the second compartment.

US 2011 0 120 993 (Birchmeier et al) discloses a multi-component package comprising: a lower container configured to contain a first filled food product, having an opening and a flange provided on the peripheral edge of the opening, and a lower container lid material for sealing the opening; and an upper container for containing a second filled food product, having an opening, a containing portion and a flange extending from the peripheral edge of the opening below the bottom part of the containing portion to enclose the side surface of the containing portion, and an upper container lid material for sealing the opening. The flange of the lower container and the of the upper container main body are configured so that the lower container and the upper container can couple to each other, with at least one vapour vent provided in the lower container lid material, whereby the water vapour generated upon heating the first filled food product is released from the lower container to heat the second filled food product of the upper container.

EP2204114 (Backaert et al) discloses a microwave steam cooking container system for cooking foodstuff, comprising a water reservoir, a food container comprising a plurality of apertures on a bottom thereof, an outer wall portion and an inner wall portion with a microwave shielding material encapsulated between said inner and outer wall portions, and a cover comprising an inner wall portion and an outer wall portion with a microwave shielding material encapsulated between them, wherein the food container is stacked and removably placed in the reservoir so foodstuff to be cooked is shielded from direct exposure to microwave energy.

EP1419721 (Kim) discloses a cooking vessel used with microwave ovens. US2011/0017078 (O'Connell) discloses an energy efficient cooking set with separate regions. US2009/0078125 (Pawlick et al) discloses an oven cooking apparatus for facilitating the cooking of food components.

There remains a need for a ready-to-cook food product that provides consumers with a quick, simple and effective way of preparing a nutritious hot meal, especially using fresh ingredients. Furthermore, there remains a need for a simple, robust and cheap packaging product for storing and steaming food items.

### SUMMARY OF THE INVENTION

The present invention provides, according to a first aspect, a container for storing and steaming food, the container comprising a first compartment for containing a steam source and a second compartment for containing at least one food item. For example, it may be that the first compartment is configured to contain a steam source, and the second compartment is configured to contain at least one food item. Preferably, the second compartment is disposed above the first compartment. For example, it may be that the configured such that second compartment is disposed above the first compartment in use. It will be appreciated that at least part of the second compartment (e.g. substantially all, for example all, of the second compartment) is disposed above at least part of the first compartment (e.g. substantially all, for example all, of the first compartment). Alternatively, it will be appreciated that other arrangements are possible, e.g. with the second compartment arranged adjacent the first compartment. Preferably, the first compartment is separated from the second compartment by a partition and an adjustable barrier, the partition comprising at least one opening for admitting water vapour into the second compartment from the first compartment. Preferably, the adjustable barrier is movable from a) a food storing configuration in which the adjustable barrier inhibits (e.g. prevents) flow of at least one of i) liquid and ii) gas from the first compartment to the second compartment, to b) a food steaming configuration in which at least one of i) liquid and ii) gas is able to flow between the first and second compartments. Preferably, the adjustable barrier prevents the flow of both liquid (such as water) and gas (such as water vapour) from the first compartment to the second compartment when in the food storing configuration. Preferably, the adjustable barrier allows the flow of gas (such as water vapour/steam) between the first and second compartments when in the food steaming configuration. It will be appreciated that the adjustable barrier may, for example, be removed from the container when in the food steaming configuration.

It will be appreciated that the container is ‘in use’ when the container is used to store food and/or to steam food. It may be that disposing the second compartment above the first compartment makes a more efficient use of space, e.g. shelf space, when the container is used to store a food item. It may be that disposing the second compartment above the first compartment improves cooking efficiency when the container is used to cook a food item. For example, it will be appreciated that hot steam rises, and so will be encouraged to pass from the first compartment to the second compartment when the compartments are so arranged.

It will be appreciated that, since the container is for storing food, it should be capable of safely and effectively storing food for an extended period of time, for example at least 3 days, such as at least 1 week. Optionally, the container is for storing food in a refrigerated environment, such as at a temperature of from 0° C. to 8° C., such as 0° C. to 5° C. Additionally or alternatively, the container may be for storing food in a non-refrigerated environment, e.g. wherein the container is for storing shelf-stable food. It may be that a container is suitable for storing food when the container provides a substantially airtight enclosure for the food. For example, it may be that the container provides physical, chemical and/or biological protection for the food. It will be appreciated that, since the container is a container for food, at least those parts of the container that will come into contact with the food during normal use should be manufactured from a food-safe material.

It will be appreciated that the adjustable barrier may be provided in any suitable form, for example being a barrier that is movable from the first food storing configuration to the second food steaming configuration by sliding, rotating, twisting, unpeeling or unclipping, preferably by unpeeling. Additionally or alternatively, the adjustable barrier may, for example, be configured to be punctured, torn or cut in order to move the barrier from the first food storing configuration to the second food steaming configuration. Optionally, the adjustable barrier is a single-us barrier, for example a non-replaceable barrier.

The steam source may be in any suitable form, for example a water-based liquid or a water based gel. It will be appreciated that the steam source may function only as a steam source, or, for example, could form a part of the end food product. For example, the steam source may be an edible sauce or an edible broth. Alternatively, the steam source may be water. Additionally or alternatively, the steam sauce may be a food item having a higher water content than the food item(s) contained in the first compartment.

Optionally, the adjustable barrier is a removable barrier, wherein the adjustable barrier is movable from the food storing configuration to the food steaming configuration by removal of the adjustable barrier from the container. It may be that having a removable barrier ensures that the barrier cannot accidentally move back to the food storing configuration while the food item is cooked.

Preferably, the adjustable barrier is configured to cooperate with the partition. For example, the adjustable barrier may cover the at least one opening of the partition when the adjustable barrier is in the food storing configuration. Additionally or alternatively, the adjustable barrier may, for example, be attached to the partition when the barrier is in the food storing configuration. Optionally, when the adjustable barrier is attached to the partition, it is attached to the side of the partition facing the first compartment. It will be appreciated that the barrier need only extend across the opening(s) of the partition when so arranged. Optionally, the adjustable barrier comprises at least one projection corresponding to the at least one opening of the partition. For example, it may be that when the adjustable barrier is in the food storing configuration, each opening of the partition is filled by a projection of the adjustable barrier. Optionally, the adjustable barrier and the partition are configured to provide a resistance fit between each projection and its corresponding opening.

Preferably, the partition forms at least one of i) a base and ii) one or more sidewalls of the second compartment. Additionally or alternatively, the adjustable barrier may, for example, form a top of the first compartment. Such arrangements may provide for a particular simple and material-efficient construction. Optionally, the partition and the adjustable barrier together form at least one of i) a base and ii) one or more sidewalls of the second compartment. Additionally or alternatively, the partition and the adjustable barrier optionally together form a top of the first compartment. Preferably, the first compartment comprises a single entrance, optionally wherein at least one of the adjustable barrier, and the partition, is configured to close the entrance.

Preferably, the container comprises a lid for closing at least the second compartment. Optionally, the lid is a removable lid. Optionally, the adjustable barrier, the partition and the lid cooperate to close the first compartment. Optionally, the container comprises a sealing member for closing the second compartment, such as a removable sealing member. Optionally, the sealing member provides a tamper-proof seal. Optionally, the sealing member and the lid cooperate to close the second compartment. Optionally, the sealing member is independent of the lid. Alternatively, the sealing member is intrinsic to the lid. Preferably, the sealing member is a single use sealing member. It will be appreciated that the lid may be attachable to the rest of the container by any suitable mechanism, including but not limited to a screw-fit attachment and/or a resistance fit attachment. Additionally or alternatively, the sealing member is configured to hold the lid in place to close the at least the second compartment, optionally to close both the first and second compartments.

Optionally, at least a portion of the partition is in the form of a mesh. For example a mesh arranged with a majority of its surface area comprising openings and a minority of its surface area comprising partition material.

Optionally, the second compartment is divided into a first volume and a second volume, the first and second volumes being separated by a divider, such as a perforated divider. It may be that so dividing the second compartment allows for increased flexibility in the type of foods stored and cooked in the container. For example, such an arrangement may permit the storing of foods that are better stored while physically separated, and/or permit consumers to conveniently eat certain foods separately. Preferably, the divider is removable from the container. Such an arrangement may, for example, allow the container to be more conveniently used as a bowl once the food is cooked, and/or give consumers the option to mix the foods together prior to cooking. Optionally, the second volume is disposed above the first volume when the container is assembled for use. Alternatively, the second volume is disposed beside the first volume when the container is assembled for use. It will be appreciated that the second compartment may be divided into any number of volumes, for example with at least one volume disposed above a first volume and at least one volume disposed beside the first volume. It will be appreciated that such arrangements may, for example, allow for greater flexibility in the cooking and presentation of foods. For example, food items with a shorter cooking time/lower cooking temperature may benefit from being contained in a volume above a volume containing food items with longer cooking times/higher cooking temperatures.

Optionally, the container comprises at least one additional compartment for containing at least one additional food item. Preferably, the (optionally each) additional compartment is disposed above the first compartment. Optionally, an additional compartment of the container is disposed adjacent the second compartment. Additionally or alternatively an additional compartment of the container is disposed above the second compartment. It will be appreciated that the additional compartment(s), if present, may, for example, be so disposed when the container is in use. Optionally, the at least one additional compartment, if present, is separated from at least one of i) the first compartment, ii) the second compartment, and iii) another additional compartment, by an additional partition comprising at least one opening for admitting steam into said additional compartment. Additionally or alternatively, at least one additional compartment, if present, is permanently separated from at least one of i) the first compartment, ii) the second compartment, and iii) another additional compartment, so as to prevent admittance of steam into said additional compartment (e.g. separated by a partition without openings). For example, when the container comprises two additional compartment, it may be that the ‘additional compartment’ is a third compartment, and ‘another additional compartment’ is a fourth compartment. Optionally, when the container comprises an additional partition comprising at least one opening, the container comprises a corresponding additional adjustable barrier movable from a) a food storing configuration in which the additional adjustable barrier prevents flow of at least one of i) liquid and ii) gas into the additional compartment, to b) a food steaming configuration in which water vapour is able to flow into the additional compartment. Optionally, the container comprises a corresponding additional adjustable barrier for each additional partition comprising at least one opening. It will be appreciated that any feature disclosed herein in relation to one adjustable barrier of the container may be combined with any other adjustable barrier of the container. For example, the or each additional adjustable barrier is optionally attached to its corresponding additional partition when in the food storing configuration, and/or the or each additional adjustable barrier is optionally removable.

Preferably, the first compartment is located in a first vessel and the second compartment is located in a second vessel. Preferably, the first vessel is separable from the second vessel. It may be that locating the first and second compartments in separable first and second vessels provides a convenient construction. Furthermore, such an arrangement may allow the consumer to quickly and easily combine contents of the first and second compartments if, for example, the steam source is a sauce or a broth. Optionally, the first vessel, the second vessel, or both the first and the second vessel is in the form of a cup. Optionally, the or each additional compartment is located in a corresponding additional vessel. Preferably, each additional vessel is separable from one or both of the first and second vessels, and/or from each other.

Preferably, the first vessel comprises an entrance, such as a single entrance. Optionally, at least part of the second vessel is insertable into the entrance of the first vessel. It will be appreciated that the entrance to the first vessel is also an entrance to the first compartment. Preferably, when the second vessel is inserted into the entrance of the first vessel, the second vessel closes the entrance to the first vessel. Optionally, when the container comprises at least one additional vessel, the second vessel and one or more additional vessels are together insertable into the entrance of the first vessel, preferably to close the entrance to the first vessel. Preferably, the second vessel comprises an entrance, such as a single entrance, wherein the container comprises a member for closing the entrance of the second vessel. It will be appreciated that said entrance of the second vessel is separate to the at least one opening of the partition between the first and second compartments. Optionally, the member for closing the entrance of the second vessel is selected from the list consisting of a lid and an additional vessel, for example an additional vessel insertable into the entrance of the second vessel, preferably and additional vessel containing an additional compartment. Optionally, the first vessel, the second vessel and the member for closing the entrance of the second vessel cooperate to entirely close the first compartment and the second compartment when the first and second vessels and the member are assembled together.

Optionally, the first vessel is releasably connectable to the second vessel. Optionally, when the container comprises at least one additional vessel, the or each additional vessel is releasably connectable to at least one of a) the first vessel, b) the second vessel, and c) another additional vessel. It will be appreciated that such an arrangement may help to keep the vessels together when the container is used to store and steam food. Optionally the second vessel is at least partially insertable into the first vessel, for example wherein the second vessel is entirely insertable into the first vessel (i.e. substantially or entirely the whole of the second vessel can be inserted into the first vessel). In other words, the first and second vessels may be at least partially stackable, for example being stackable cups. Optionally, all of the vessels of the container are stackable to assemble the container, for example all of the vessels are stackable cups. It will be appreciated that when the second vessel is entirely insertable into the first vessel, the second vessel may sit within the bounds of the first vessel without being encapsulated by the first vessel, for example the first vessel may have an open top. Preferably, one or both of the first and second vessels comprises a base and at least one upstanding sidewall. Optionally, the base of the second vessel forms at least part of the partition between the first and second compartments. Additionally or alternatively, the at least one upstanding sidewall of the second vessel optionally forms at least part of the partition between the first and second compartments. Optionally, the sidewall of the first vessel is configured to surround at least a portion of the second vessel, optionally wherein the sidewall of the first vessel is configured to surround at least a portion of the at least one upstanding sidewall of the second vessel.

Preferably, the container additionally comprises a lid for closing at least the second vessel. Preferably, the lid is a removable lid (that is, a lid that is separable from the first and/or second vessel). Optionally, the container comprises a first lid for closing the first vessel, and a second lid for closing the second vessel. Optionally, the first vessel, the second vessel and the lid cooperate to entirely close the first compartment and the second compartment when the first and second vessels and the lid are assembled together. Optionally, the lid is configured to engage with both the first vessel and the second vessel. Optionally, the container comprises at least one sealing member for sealing (such as hermetically sealing) at least the second compartment, or the first and second compartments. For example, it may be that the sealing member provides a seal between a lid and the first and/or second vessels. Optionally, the sealing member provides a tamper-proof seal. Optionally, the sealing member is separate to the lid, for example in the form of a removable film. Alternatively, it may be that the sealing member is intrinsic to the lid, for example in the form of a gasket.

Optionally, the adjustable barrier is attached to the first vessel when the adjustable barrier is in the food storing configuration. Additionally or alternatively, the adjustable barrier is attached to the second vessel when the adjustable barrier is in the food storing configuration. Optionally, the adjustable barrier is attached to the outside of the second vessel when the adjustable barrier is in the food storing configuration. It will be appreciated that the outside of the second vessel may nevertheless be an inner surface of the container, for example when the first and second vessels are at least partially stackable.

Preferably, the partition comprises a plurality of openings, for example at least 3, optionally at least 5, such as at least 10 openings. It will be appreciated that having a plurality of openings may help facilitate effective flow of steam from the first compartment to the second compartment. Preferably, the plurality of openings is distributed across the partition, for example across one or more faces of the partition. Optionally, each opening has a minimum diameter of no more than 20 mm, for example no more than 10 mm, such as no more than 5 mm. Additionally or alternatively, each opening has a maximum diameter of at least 1 mm, for example at least 10 mm, such as at least 20 mm. Alternatively, it may be that the plurality of openings are provided by a permeable material, such as a water vapour/steam-permeable material. It may be that so dimensioned openings provide a balance between allowing adequate flow of steam from the first compartment to the second compartment and preventing unwanted passage of food items from the second compartment to the first compartment. Optionally, at least some, for example all, of the openings are provided in the base of the second vessel. Additionally or alternatively, at least some, for example all, of the openings are provided in the at least one upstanding sidewall of the second vessel.

Optionally, the adjustable barrier is in the form of a film, for example a peelable film. It will be appreciated that the film may be made from any suitable flexible material, preferably a lightweight flexible material. It may be that a film provides a particularly lightweight and simple to manufacture adjustable barrier. Furthermore, it may be that a film provides an adjustable barrier that cannot easily be put back into place, thus providing a tamper resistant adjustable barrier. Preferably, the film is a polymeric film, for example a plastic material film, such as a polyethylene-based film. It will be appreciated that a peelable film is a film that can be moved from the food storing configuration to the food steaming configuration by unpeeling the film. Preferably, the adjustable barrier is secured in the food storing configuration by an adhesive, for example by a pressure sensitive, or heat sealing adhesive. It will be appreciated that an adhesive may be an effective way of holding the adjustable barrier in the food storing configuration, while also helping to provide a liquid and/or gas barrier between the first and second compartments.

Optionally, the container for storing and steaming food is a microwavable container. For example, it may be that the container is manufactured from a microwave-safe material, such as a plastic and/or card material. It will be appreciated that the container may, for example, be provided with, or packaged within, a non-microwave safe material that can be removed from the container prior to inserting the container into a microwave oven.

Optionally, the container is a single use container. Alternatively, it may be that the container is a re-usable container.

According to a second aspect, the present invention provides a packaged food product comprising a container according to the first aspect of the invention, wherein the second compartment of the container contains at least one food item. Preferably, the first compartment of the container contains a steam source, for example a water-based liquid or a water-based gel. Optionally, the steam source is an edible sauce or an edible broth. Optionally, the second compartment contains a plurality of different food items. Optionally, when the second compartment is divided into a first volume and a second volume, at least one food item is contained in the first volume and at least one different type of food item is contained in the second volume.

According to a third aspect, the present invention provides a method of packaging a food product, the method comprising inserting at least one food item into the second compartment of a container according to the first aspect of the invention. Preferably, the method comprises inserting a steam source into the first compartment of the container, for example wherein the steam source is a water-based liquid or a water-based gel. Optionally, the steam source is an edible sauce or an edible broth. Preferably, the method comprises sealing the second compartment from the ambient environment, and optionally sealing the first compartment from the ambient environment. It will be appreciated that the ambient environment is the environment outside of the container.

According to a fourth aspect, the present invention provides a method of cooking a food item, wherein the method comprises: providing the packaged food product according to the second aspect of the invention, optionally inserting a steam source into the first compartment of the container if the container does not comprise a steam source, moving the adjustable barrier from the food storing configuration to the food steaming configuration; and exposing the steam source to heat to generate steam.

According to a fifth aspect, the present invention provides apparatus for cooking in a microwave oven comprising: a plurality of volumes which are interconnected in use; the volumes are defined by one or more containers which are microwave-safe and include a base and an entrance to the volume; the volumes are fluidically interconnected by one or more perforations provide on at least one container; and the perforation(s) on at least one container are covered by a displaceable seal.

In this way different food types are separated in the apparatus and fluidic connection is only permitted when the seal is removed. After the seal is removed and as the apparatus and food therein are heated, heated air and steam are able to pass through the perforations into different volumes to permit cooking of the food.

In some embodiments the apparatus may comprise a single-use apparatus, available for example, at point of purchase with foodstuffs in the volumes. In some other embodiments the apparatus may comprise a reusable apparatus, with the volumes filled in use.

In some embodiments the containers may comprise wholly discrete containers, being displaceable one from another, which are interconnected or stackable in use. Such containers may comprise an entrance to a bounded volume (or container) and a base, upon which base the container may be rested, so as to enable the volume to be used as a serving bowl for example.

The seal is provided adjacent the perforations so as to close the perforations and prevent mixing of contents from one volume to another. Advantageously this may increase the shelf life of foodstuffs within the apparatus.

The provision of separate volumes may also improve food quality by permitting food stuffs to cook in separate volumes prior to consumption.

In some embodiments the apparatus comprises at least one lid. In some embodiments each entrance to a volume is closed by a lid. In this way each lid is displaceable so as to create an entrance to a respective container.

In some embodiments the entrance may be covered before use by a second hermetic seal member. This may be in addition to the lid or as an alternative to a lid. For example this second seal member may be wholly displaceable prior to use, so as to unseal any foodstuffs for cooking purposes.

Therefore the lid and/or second seal member may be interchangeable and/or comprise one same thing. The lid and/or seal member may be single-use and disposable.

In other embodiments the lid may comprise a replaceable or re-usable part. For example in some embodiments the second seal member may be a separate part to the lid, wherein the lid may be placed on the entrance, or otherwise over the volume, after the first seal member has been displaced.

In some embodiments the lid may comprise a resiliently deformable seal or catch, so as to catch over the entrance, container, apparatus or volume and held in place.

In this way the apparatus has two seals: a first seal that closes the perforations, and a second seal that closes the entrance to the volume.

In some embodiments the volumes are bounded in use to one face by the entrance and to other faces by the outer. This outer therefore may be envisaged to provide a continuous side or sides, with a bottom, wherein the bottom is substantially parallel to or opposite the entrance. Optionally the entrance may be substantially planar so as to enable an outer container to be stood on a flat surface.

In some other embodiments the bottom may comprise a rim, which rim provides a contact with the surface. In this way the bottom may be non-planar albeit without depending below the rim.

At least one of the adjoining containers has perforations to permit heated air and steam to pass from one volume to another. Preferably the perforations are provided through a base of one container that connects to a second container. It is appreciated that the outer container has no perforations to prevent escape of contents from the apparatus. The perforations may be provided by a permeable material or structure and/or plurality of perforations such that moisture, steam or heated air is able to pass through the bottom of one container into another. The perforations on at least one container are covered by the first removable seal so as to fully separate food types into different compartments until cooking.

The first seal is typically a flexible layer that is arranged adjacent to the perforations on the base of the container. Preferably the first seal is provided on a lower face of a container, typically its base, so that it can be readily removed without contacting food contents whilst still ensuring the contents remain in the container.

The first and second seals may be provided by means of in mould labelling and use of an adhesive so as to secure a seal or heat sealing portion around rim of a container or around one of its inner or outer surfaces. The seals may be formed from any heat safe, food safe material. Typically the seals are from synthetic plastics film.

In some embodiments the first and second seal members may be reusable. For example the first and second seals being silicone layers that are arranged over the entrance of a volume to seal contents or over the perforations to seal contents.

In some embodiments a reusable seal may include projections that correspond to the perforations on a base or divider so that each perforation is filled with a projection in order to close each perforation and to create a seal between an adjacent volume or between a volume and an outer environment. The interconnection between the projections and perforations is a resistance fit that serves to hold the seal adjacent and in contact with the perforations.

Preferably there are two seals and both the first and second seals are peeled away prior to use or cooking.

In some embodiments other areas of the outer comprise perforations in addition or the alternative. For example in some embodiments the sides may comprise perforations and/or permeability. In some embodiments the bottom may comprise perforations and/or permeability incident the rim for example.

In some embodiments the lid may comprise perforations in addition or the alternative.

In some embodiments the bottom comprises a mesh, arranged with a majority of perforation and a minority of bridging material.

In some embodiments the perforations comprise one-way valves, for example wherein the perforations are covered by a resiliently deformable coating, and/or the perforations are exposed by passage of air or fluid.

Typically containers are stacked one atop, or partially within another. In this way the number of volumes can be selected for the food type to be contained.

In some embodiments at least one of an upper container is able to fit wholly or partly within a lower container, for example where part of the upper container suspends off the lower container. For example an upper container may comprise a radially extending lip which sits on the lower container. The lower container may comprise a support surface for the lip, for example its top edge or a radially extending rim. In this way the lid may cover the stacked containers.

In some embodiments the sides of the upper container may comprise a more oblique angle than the lower container's sides such that spacing may be developed between the sides of the containers. In this way the sides of the upper container may be perforated effectively.

In the above way the apparatus provides a microwavable convenience steaming apparatus which functions by comprising of two or more containers that are stacked into one convenient unit. In use each volume holds a food element that can be microwaved.

For example wherein a lower volume holds a liquid or sauce such as soup, sauce, broth or curry, then a top volume/s sits above and in some embodiments inside the lower volume, above the liquid.

The apparatus thereby allows users to have fresh food in one convenient microwavable product, allowing the different elements of a meal to be heated separately so they do not become stodgy, congealed or mushed together. The invention allows for example, noodle soup to be sold and eaten fresh without the noodles and pasta having to be stored in a broth or soup and so avoids the noodles or pasta from becoming soggy over time, In another arrangement fresh vegetables such as broccoli may be added to a stir fry with rice without the need for the broccoli to have to remain in a sauce, thereby again avowing it from becoming soft and stodgy whilst on a shop shelf. The invention therefore allows for fresh convenience food to be prepared as an instant type food when a consumer may be ‘on the go’, such as during a short lunch break or for a quick, convenience meal.

The apparatus allows for healthy fresh alternatives to stodgy products that are already available and just require water in order to rehydrate them.

The upper container has a perforated or steam permeable outer to allows steam to penetrate through to the contents of the upper container whilst the apparatus is microwaved. This steam comes from the liquid or sauce during heating and then heats and warms food in the top volume such as, noodles, rice, pasta, vegetables.

The apparatus thereby allows for fresher home cooked meals to be assembled, using only one microwavable apparatus with layered volumes. The apparatus may be double layered or triple layered, with vertically stacked volumes, and/or the top container may be subdivided into horizontal volumes for separate foods.

Volumes may be subdivided in use within a single container, for example wherein a perforated divider may be displaceably situated within a volume.

The perforated divider may be a perforated disc arranged in use within a container to separate the volume into compartments. Typically the container is adapted to receive the disc such that it is received and sits in a fixed position that separates one food item from another. For example, the container may have a ridge upon which the divider sits in use.

In some embodiments the divider may include a handle to permit the divider, such as the disc, to be easily lifted from the container to permit removal of the seal.

The handle is typically an elongate member that extends from the divider so that it can be grasped by a user.

In some embodiments the handle may be detachable part that it connected to the divider for removal and insertion purposes. The divider may be adapted to receive the handle, for example having connector for receiving the handle removable manner, such as an aperture through which part of the handle is passed in order to be secured to the divider. For example the handle may fit to the divider by a hook and eye mechanism, a twist lock, a snap fit or other interlocking means.

In some embodiments the divider may be shaped to be slightly concave to define a recess in which the food stuffs sit so that food stuff is less liable to fall from the divider when it is lifted out to remove the seal.

In another embodiment the divider may include a raised lip around a perimeter edge to provide a barrier to prevent food from falling from the divider during removal from and insertion to the container. In this way the divider may by in the form of a basket.

In yet a further embodiment the divider may include baffles to help keep food stuffs spread across the perforations to enhance even cooking of food stuffs.

It is appreciated that baffles may also be provided across the base of a container to perform the same function.

The perforated divider may receive a seal to close the perforations in the same way in which perforations of the container are closed. Any of the above mentioned seals may be provided to close the perforations of a divider.

In some embodiments the seal may also connect with the container in order to prevent leakage around edges of the divider. Alternatively, the divider may have a sealing edge that engages with the container to form a seal. For example the edge of the divider may be formed from a resiliently deformable material such as silicone.

In some embodiments variation in perforations may be used to interconnect volumes, for example vertically and/or horizontally, for example wherein dividers may be used collaboratively, cumulatively or in variant horizontal or vertical arrangements. Such dividers may interconnect, for example by clip mechanism.

In still further embodiments containers may be inserted into or within other container volumes.

The apparatus may comprise a mechanism to interconnect the containers, for example wherein the containers are held in place to prevent mutual movement through the steam action. For example in some embodiments the containers may interconnect through a screw thread or bayonet mechanism, and/or resiliently deformable seals or catches.

In some embodiments each of the lower container and the upper container or containers are formed of a material that is suitable for use in a microwave or conventional oven. Various constructions may be used to create the air permeability, such as lugs, ledges and lips.

The trays may be nested loosely for ease of removal of the upper container(s) from the lower container(s). Various configurations of cover may be used such as a sleeve, carton or lid.

The apparatus is formed from cooking proof, food safe materials. Preferably the apparatus is formed from synthetic plastics. In some embodiments, part or all of the apparatus may be formed from card.

In some embodiments the apparatus may be suitable for us in an oven, in addition to a microwave oven.

It will of course be appreciated that features described in relation to one aspect of the present invention may be incorporated into other aspects of the present invention. For example, any feature described in relation to the first aspect of the invention may be combined with any feature described in relation to the fifth aspect of the invention. In this regard, it will be appreciated that the interconnected volumes of the fifth aspect of the invention correspond to the first and second compartments of the first aspect of the invention, the containers of the fifth aspect of the invention correspond to the vessels of the first aspect of the invention, the one or more perforations provided on at least one container according to the fifth aspect of the invention correspond to the openings of the partition of the first aspect of the invention, and the displaceable seal of the fifth aspect of the invention corresponds to the adjustable barrier of the first aspect of the invention. It will be further appreciated, however, that any feature implicitly or explicitly described as essential to the fifth aspect of the invention is not necessarily essential to the first aspect of the invention.

### DESCRIPTION OF THE DRAWINGS

Embodiments of the present invention will now be described by way of example only with reference to the accompanying schematic drawings of which:

FIG. 1 shows a diagrammatic side view of a first embodiment of apparatus according to the present invention, in an interconnected configuration;

FIG. 2 shows a diagrammatic side view of the embodiment of the apparatus shown in FIG. 1, in a separated configuration;

FIG. 3 show a diagrammatic side view and a diagrammatic top view of a second embodiment of the apparatus according to the present invention;

FIG. 4 show sketches of isometric views of a third embodiment of the apparatus according to the present invention, in a separated configuration and a stacked configuration respectively;

FIG. 5 shows a diagrammatic side view of a fourth embodiment of the apparatus according to the present invention;

FIG. 6 show sketches of isometric views of the fourth embodiment of the apparatus as shown in FIG. 5;

FIG. 7 shows an exploded view of a stacked arrangement of the apparatus;

FIG. 8 shows a cross-sectional view of a container according to the invention with the adjustable barrier in the food storing configuration;

FIG. 9 shows a cross-sectional view of another container according to the invention with the adjustable barrier in the food storing configuration;

FIG. 10 shows a cross-sectional view of the containers of FIGS. 8 and 9 with the adjustable barrier in the food steaming configuration;

FIG. 11 shows a cross-sectional view of yet another container according to the invention;

FIG. 12 shows the steps of a method of packaging a food product according to the invention; and

FIG. 13 shows the steps of a method of cooking a food item according to the invention.

### DETAILED DESCRIPTION

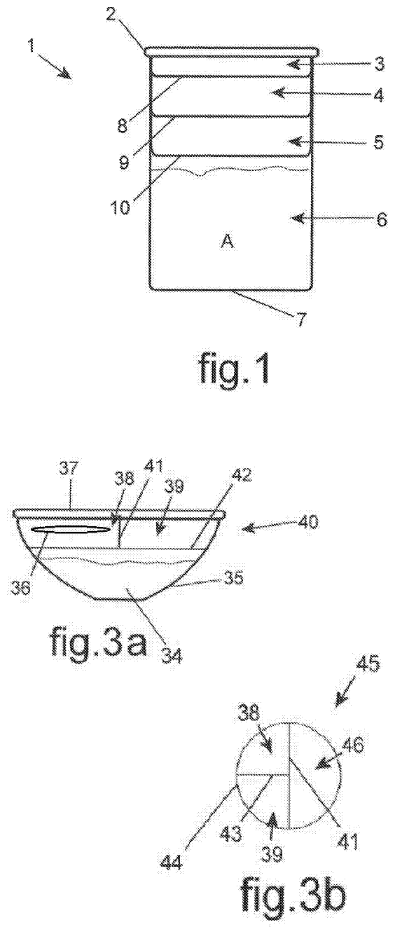

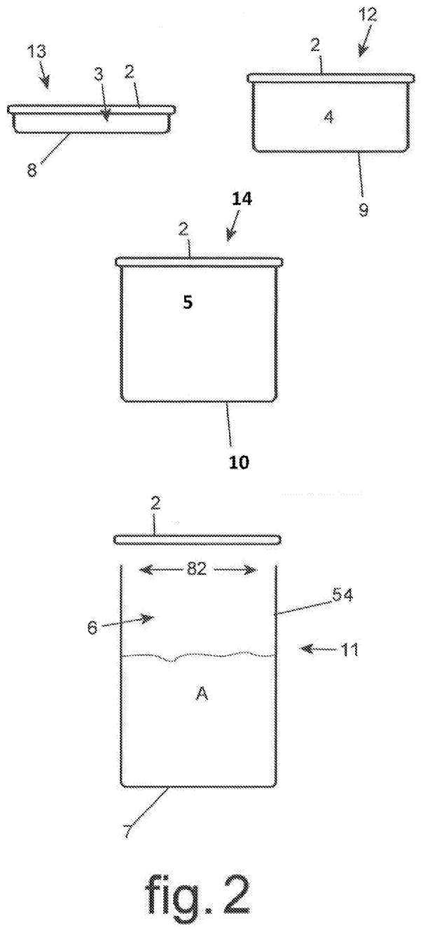

With reference to FIGS. 1 and 2 there is shown an embodiment of the apparatus 1 comprising three discrete containers/vessels 11, 12, and 13 (see FIG. 2), which containers/vessels are usable as separate serving dishes, and which are interconnected or stacked together so as to be enabled to allow simultaneous cooking, in a microwave.

The apparatus 1 is arranged for cooking in a microwave, and the containers/vessels 11, 12 or 13 comprise a plurality of internal volumes/compartments 3, 4, 5 and 6, which volumes/3, 4, 5 and 6 are interconnected in use, the containers 11, 12 or 13 further comprising a microwave-safe outer 54, bases 7, 8, 9, and 10, and each container/vessel an entrance 82 to the volume, wherein the apparatus comprises one or more perforations/openings in the interconnecting containers.

The entrance 82 to volume 3 is closed by a lid 2.

The bottoms 8, 9, 10 of the upper containers 12, 13, 14 are perforated with openings so as to allow passage of heat, steam, fluid or moisture, so as to provide cooking gases throughout the apparatus 1 in use.

The perforations are in the bases 8, 9, 10 of the upper containers 12, 13, 14 which relates to below the volumes. The lowest container 11 has a solid base 7, wherein the volume 6 contains a body of fluid A.

The upper containers 12, 13 and 14 may be fixed in place with a twist and seal mechanism (not shown), comprising an inverted thread mechanism around the inner top of the bottom container and the outer top of the upper container to allow for the container to be watertight and not leak in transit.

A twist and seal method is the preferred choice however this could be achieved using a rubber ring, lips and ledges and even a clasp over clip down and fasten or over-centre mechanism.

The apparatus provides microwavable and recyclable containers, namely a volume with a perforated bottom to sit above a liquid filled volume.

The apparatus has second, pull off seal members/adjustable barriers (not shown) to close the perforations 8, 9 and 10. The second seal member is removed prior to cooking. It is appreciated that for some uses seals may be removed at different times during cooking to reflect different cooking times of contents.

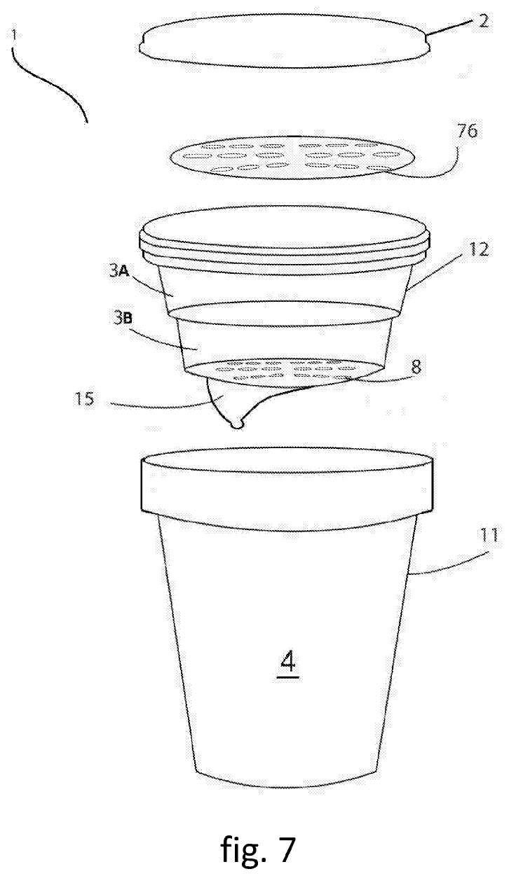

A second seal/adjustable barrier is shown in FIG. 7 covering the container perforated bottom 8 (the second seal being indicated by reference numeral 15).

In the embodiment of the apparatus shown in FIGS. 3 a sealed pouch 36 sits in a volume/compartment 38 of a tray upper container/vessel 45. The pouch 36 holds fresh chopped accompaniments to be removed prior to cooking.

The embodiment is circular in plan and comprises an upper container 45 horizontally divided into three volumes 36, 39 and 46, namely two quarter segments divided from each other by a vertical wall 43, and from a half segment 46, divided by another vertical wall 41. The whole comprises a circular perimetric lip 44 for hanging onto the top edge of the lower container 40.

The lower container is circular in plan, with a flat bottom and wider top edge with opening sides 35.

The upper container 45 comprises a locking mechanism to seal the lower container 40 to the upper container 45, such as twist and seal.

The embodiment of the apparatus further provides a lid 37 for the upper container 45, and may include disposable cutlery to go with it, i.e. wooden chopsticks, plastic spoon, fork etc.

The apparatus may be safety sealed in the factory and in use: the user removes any outer packaging, opens the lid 37 taking out the pouch 36, lifts out the upper container 45 and removes from the perforated bottom 42 a pull off tab/adjustable barrier, then seals the upper container 45 back onto or into the lower container 40, places the lid 37 gently on top and microwaves for the recommended time. Once microwaved they let stand then remove the upper container 45, and assemble their meal on a plate or in a bowl, or they put their ingredients from the upper container volumes 38, 39 and 46 into the bottom volume and add the fresh ingredients form their fresh pouch on top and eat.

One of the most important features of this apparatus is allowing for convenience healthy steam heated food to be eaten on the go. The layered formation enables liquid in the lower container and another foodstuff in the upper container or containers.

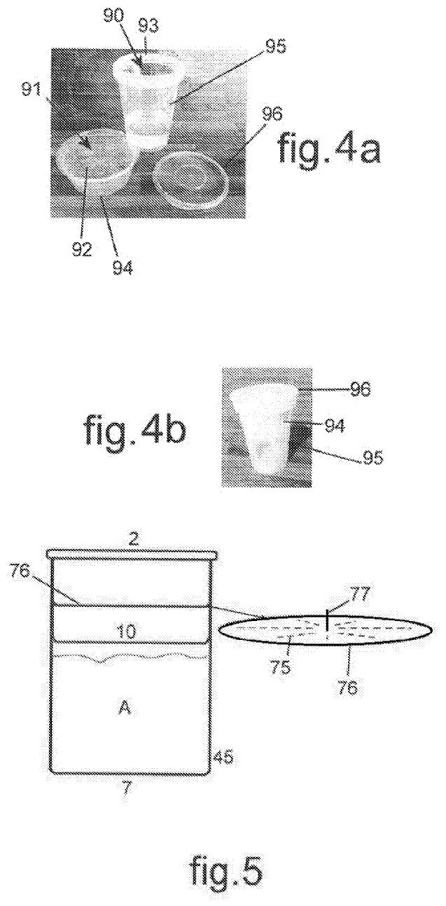

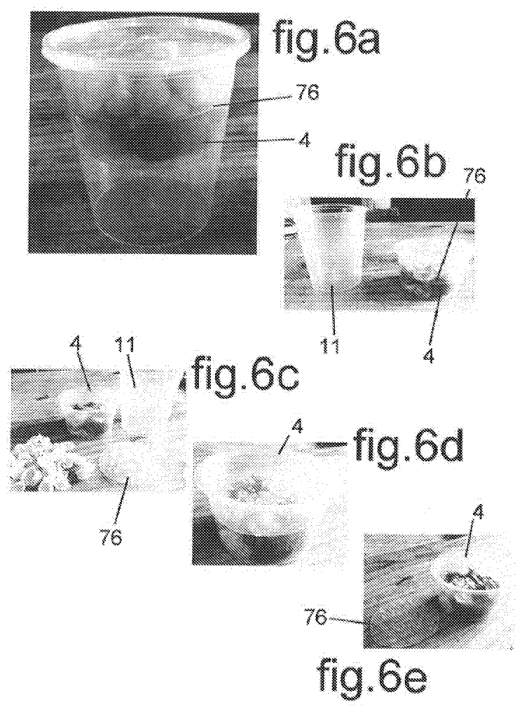

In FIGS. 5 and 6 there is shown an embodiment comprising a container/vessel separated into double volume layers with a perforated disc 76 inserted within the upper container 4.

The disc 76 comprises a vertical stick handle 77 to lift the disc 76 and make it easier for the user to separate the layers.

The disc is pictured with linear dash perforations, in all embodiments the perforations may be envisaged as any shape, for example round holes, small, intermediate or long slits.

It is appreciated that the disc may receive a seal to close the perforations. In this way one volume may have separate sealed compartments. Removal of the seal opens the perforations and permits a fluidic connection between adjoining volumes.

FIG. 7 shows an exploded view of the cooking apparatus having two volumes/compartments 3, 4 defined by two containers/vessels 11, 12.

Container 12 stacks within container 11,

Container 12 accepts a perforated disc 76 which separates container 12 into two separate volumes 3A, 3B.

The base of container 12 has perforations/openings 8. The perforations are closed by the second seal member/adjustable barrier 15 which is a removable plastic sheet. The second seal prevents contents between volumes 3 and 4 from mixing until the second seal 15 is removed.

The apparatus 1 accepts a lid 2 which closes the containers. The container is pictured as round, but embodiments may be envisaged to be capable of formation in various shapes and sizes.

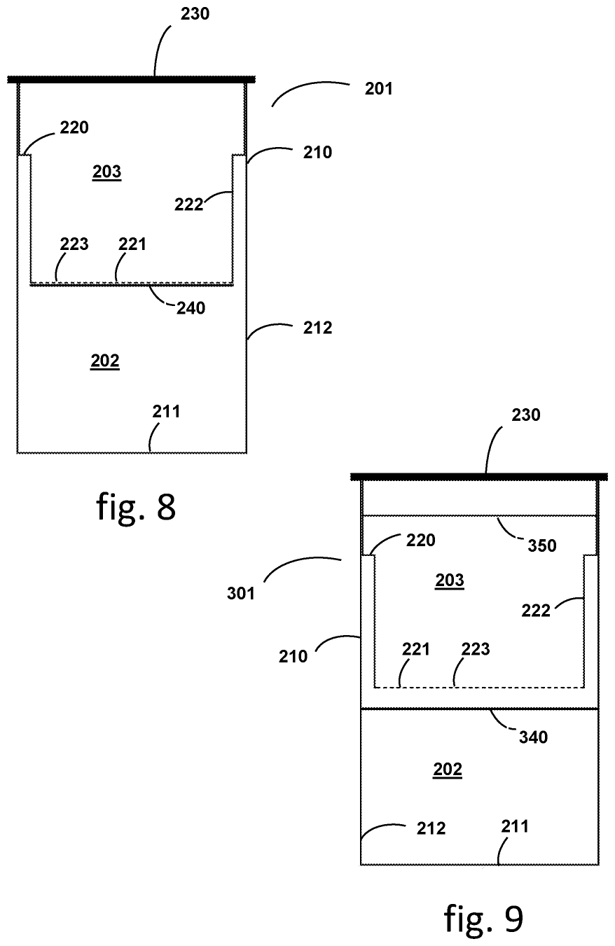

FIG. 8 shows a cross-sectional view of a container 201 according to another embodiment of the invention, the container 201 being for storing and steaming food. The container 201 comprises a first compartment 202 and a second compartment 203, the first compartment 202 being suitable for containing a sauce (not shown), and the second compartment 203 being suitable for containing food comprising noodles (not shown). The first compartment 202 is defined in a first vessel 210 having a base 211 and upstanding walls 212. The second compartment 203 is defined in a second vessel 220 having a base 221 and upstanding walls 222. When the container 201 is assembled, as shown in FIG. 8, the second vessel 220 is entirely inserted into the first vessel 210 such that the vessels form a stacked/nested arrangement. The base 221 of the second vessel 220 forms a partition between the first and second compartments 202, 203. The base 221 of the second vessel 220 includes a plurality of openings 223 for allowing steam from the sauce to pass from the first compartment 202 to the second compartment 203 when the sauce is heated. Additionally or alternatively, openings could be provided in one or more upstanding walls 222 of the second vessel 220, particularly when the walls 222 of the second vessel 220 are spaced apart from the walls 212 of the first vessel 210, as is the case in the container 201 of FIG. 8. The container 201 further comprises a removable lid 230 that engages with both the first vessel 210 and the second vessel 220 to close the first and second compartments 202, 203. The lid 230 is provided with a sealing member (not shown) that wraps around the circumferential edge of the lid 230 and the tops of the first and second vessel 210, 220, providing an airtight seal therebetween. In order to gain access to the vessels, the user removes the sealing member (which is a single-use seal that cannot be used the re-seal the vessels after opening). Alternatively, the lid 230 could be provided as a screw-fitting lid, for example held in place by one or more removable tabs. With such a lid arrangement, the sealing member could be provided in the form of a gasket that forms a seal between the lid and the upper most edge of the second vessel and/or the first vessel. In the container 201 of FIG. 8, the second vessel 220 has an outwardly depending rim (not shown) around its top allowing it to rest on the top edge of the first vessel 210. Alternatively, the first vessel 210 could be provided with a ledge upon which the second vessel 220 could rest. Still alternatively, the second vessel 220 could be attached to and suspended from the lid 230, which could in turn rest upon the top of the first vessel 210.

The container 201 further comprises an adjustable barrier 240, shown in its food storing configuration, in which the adjustable barrier 240 is affixed to the outer surface of the base 221 of the second vessel 220, covering the openings 223. The adjustable barrier 240 is a flexible plastic film that is attached to the second vessel 220 with an adhesive (not shown). To move the adjustable barrier 240 from its food storing configuration to its food steaming configuration, the user separates the first and second vessels 210, 220, unpeels the adjustable barrier 240 from the bottom of the second vessel 220, then reassembles the first and second vessels 210, 220.

FIG. 9 shows a cross-sectional view of a container 301 according to a further embodiment of the invention. Features of the container 301 that are the same as those of container 201 of FIG. 8 are labelled with the same reference numerals. The container 301 of FIG. 9 comprises and adjustable barrier 340, shown in its food storing configuration, in which the adjustable barrier 340 is affixed to the inner surface of the walls 212 of the first vessel 210. The adjustable barrier 340 is a flexible plastic film that is attached to the second vessel 220 with an adhesive (not shown). To move the adjustable barrier 340 from its food storing configuration to its food steaming configuration, the user separates the first and second vessels 210, 220, unpeels the adjustable barrier 340 from the walls 212 of the first vessel 210, then reassembles the first and second vessels 210, 220. The container 301 of FIG. 9 includes a sealing member 350 is entirely separate to the lid 230. The sealing member 350 is attached to the side walls 222 of the second vessel 220 and seals the second compartment 203. In order to gain access to the second compartment 203, the user first removes the lid 230 and then unpeels and removes the sealing member 350.

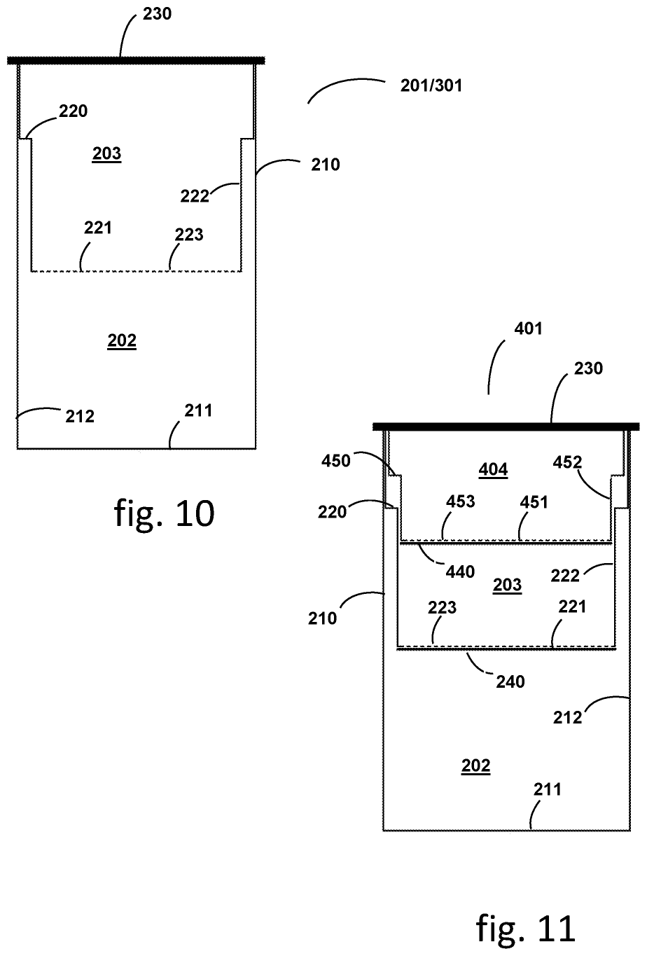

FIG. 10 shows the container 201, 301 of FIGS. 8 and 9 with the adjustable barrier (not shown) in the food steaming configuration. The container 301 is also shown with the sealing member 350 removed.

FIG. 11 shows a cross-sectional view of a container 401 according to a further embodiment of the invention. Features of the container 401 that are the same as those of container 201 of FIG. 8 are labelled with the same reference numerals. The container 401 comprises an additional compartment 404 defined in an additional vessel 450 having a base 451 and upstanding walls 452. When the container 401 is assembled, as shown in FIG. 10, the additional vessel 450 is entirely inserted into the second vessel 220, and the second vessel 220 is entirely inserted into the first vessel 210, such that the vessels form a stacked/nested arrangement. The base 451 of the additional vessel 450 forms a partition between the second compartment and the additional compartment 203, 404. The base 451 of the additional vessel 450 includes a plurality of openings 453 for allowing steam from the sauce to pass from the first compartment 202 to the additional compartment 404 (via the second compartment 203) when the sauce is heated.

The container 401 further comprises an adjustable barrier 440, shown in its food storing configuration, in which the adjustable barrier 440 is affixed to the outer surface of the base 451 of the additional vessel 450, covering the openings 453. The adjustable barrier 440 is a flexible plastic film that is attached to the additional vessel 450 with an adhesive (not shown). To move the adjustable barriers 240, 440 from their food storing configurations to their food steaming configurations, the user separates the first, second and additional vessels 210, 220, 450, unpeels the adjustable barriers 240, 440 from the bottoms of the second and additional vessels 220, 450, then reassembles the first, second and additional vessels 210, 220, 450.

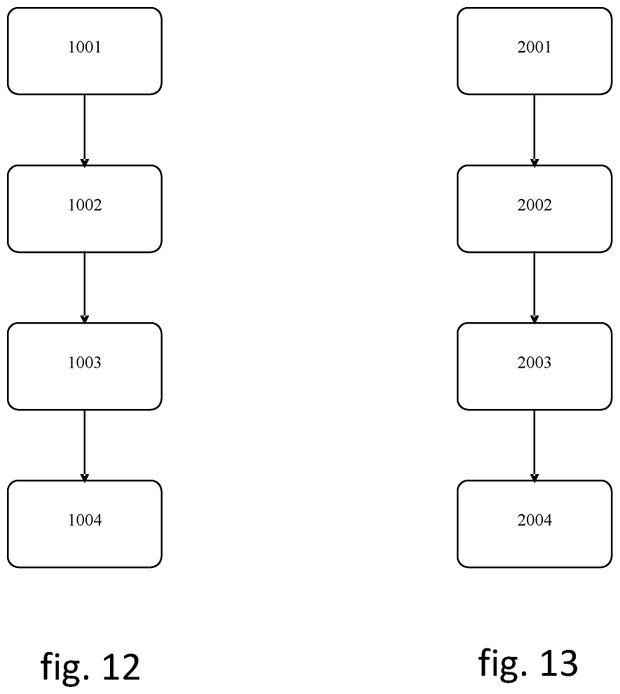

FIG. 12 shows the steps of a method of packaging a food product according to the invention. The method comprises a first step 1001 of inserting a food item (such as noodles) into the second compartment of a container according to the invention, a second step 1002 of inserting a steam source (such as a sauce) into the first compartment of said container, a third step 1003 of sealing the second compartment from the ambient environment, and a fourth step 1004 of sealing the first compartment from the ambient environment. Optionally, if the first and second compartments are located in separate vessels, the method may additionally comprise a step (not shown) of connecting together the vessels. It will be appreciated that the method may additionally comprise steps (not shown) of inserting another food item (such as vegetables) in a third compartment, sealing the third compartment from the ambient environment, and connecting the vessel containing the third compartment to the vessels containing the first and second compartments. It will be appreciated that the steps of sealing the first and second compartments may, optionally, be carried out simultaneously, and/or before or after connecting the vessels together.

FIG. 13 shows the steps of a method of cooking a food item according to the invention. The method comprises a first step 2001 of providing/obtaining a packaged food product according to the invention, a second step 2002 of inserting a steam source (e.g. water) into the first compartment of the container if it does not already contain a steam source, a third step 2003 of moving the adjustable barrier from the food storing configuration to the food steaming configuration, and a fourth step 2004 of exposing the steam source to heat to generate steam.

Further embodiments of the invention are set out in the following numbered clauses:
1. Apparatus for cooking in a microwave oven comprising: a plurality of volumes which are interconnected in use; the volumes are defined by one or more containers which are microwave-safe and each includes a base and an entrance to the volume; the volumes are fluidically interconnected by one or more perforations provided on at least one container; and the perforation(s) on at least one container are covered by a displaceable seal.
2. Apparatus according to clause 1 comprising a plurality of containers defining discrete volumes.
3. Apparatus according to clause 2 including at least one divider.
4. Apparatus according to clause 1 comprising a single container with at least one divider to define separate volumes within the container.
5. Apparatus according to any of the preceding clauses wherein the container or containers have one or more lids to close the entrance(s) to the volume.
6. Apparatus according to any preceding claim wherein an entrance has a single-use seal.
7. Apparatus according to any preceding clause wherein the perforations are arranged in the base of the container
8. Apparatus according to any of the preceding clauses wherein the perforations are arranged in the lid.
9. Apparatus according to any of the preceding clauses wherein the perforation(s) includes or comprises at least one one-way valve.
10. Apparatus according to any preceding clause including a handle.

Whilst the present invention has been described and illustrated with reference to particular embodiments, it will be appreciated by those of ordinary skill in the art that the invention lends itself to many different variations not specifically illustrated herein.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1-40. (canceled)

41. A single-use container for storing and steaming food, the container comprising a first compartment for containing a steam source, and a second compartment for containing at least one food item, wherein the second compartment is disposed above the first compartment;
wherein, the first compartment is separated from the second compartment by a partition and an adjustable barrier, the partition comprising a plurality of openings for admitting water vapour into the second compartment from the first compartment, and wherein the adjustable barrier is movable from
(a) a food storing configuration in which the adjustable barrier prevents flow of at least one of (i) liquid and (ii) gas from the first compartment to the second compartment, to
(b) a food steaming configuration in which water vapour is able to flow between the first and second compartments;
wherein the adjustable barrier is a non-replaceable barrier movable from the food storing configuration to the food steaming configuration by removal of the non-replaceable barrier from the container;
wherein the first compartment is located in a first vessel and the second compartment is located in a second vessel, the second vessel being at least partially insertable into the first vessel, and the first vessel being separable from the second vessel;
wherein the second vessel comprises a base and at least one upstanding sidewall,
wherein at least the base of the second vessel forms the partition between the first and second compartments so that the partition forms at least a base of the second compartment;
wherein the sidewall of the first vessel is configured to surround at least a portion of the second vessel; and,
wherein the container additionally comprises a lid, wherein the first vessel, the second vessel and the lid cooperate to entirely enclose the first container and the second container when the first and second vessels and the lid are assembled together.

42. The container according to claim 41, wherein the adjustable barrier is configured to cooperate with the partition, and wherein the adjustable barrier covers the plurality of openings of the partition when the adjustable barrier is in the food storing configuration, and optionally wherein the adjustable barrier is attached to the side of the partition facing the first compartment when the barrier is in the food storing configuration.

43. The container according to claim 41, wherein the adjustable barrier forms a top of the first compartment.

44. The container according to claim 41, wherein the second compartment is divided into a first volume and a second volume, the first and second volumes being separated by a divider, such as a perforated divider.

45. The container according to claim 44, wherein the divider is removable from the container.

46. The container according to claim 41, wherein the container comprises at least one additional compartment for containing at least one additional food item, optionally wherein the additional compartment is disposed above the first compartment.

47. The container according to claim 46, wherein the container comprises at least one additional partition for separating the additional compartment from at least one of a first compartment, a second compartment, and another additional compartment, the additional partition comprising at least one opening for admitting water vapour into said additional compartment, optionally wherein the container comprises at least one corresponding additional adjustable barrier movable from
(a) a food storing configuration in which the additional adjustable barrier prevents flow of at least one of (i) liquid and ii) gas into the additional compartment, to
(b) a food steaming configuration in which water vapour is able to flow into the additional compartment.

48. The container according to claim 46, wherein the at least one additional compartment is permanently separated from at least one of the first compartment, the second compartment, and another additional compartment, so as to prevent admittance of water vapour into said additional compartment.

49. The container according to claim 47, wherein each additional compartment is located in a corresponding additional vessel, each vessel being separable from each other vessel.

50. The container according to claim 41, wherein the first vessel is releasably connectable to the second vessel.

51. The container according to claim 49, wherein the first vessel, the second vessel and the additional vessel(s) are releasably connectable to each other.

52. The container according to claim 49, wherein at least one additional vessel is insertable into the second vessel, and wherein the second vessel and at least one additional vessel are together insertable into the first vessel.

53. The container according to claim 41, wherein the container is manufactured from card.

54. The container according to any claim 41, wherein the adjustable barrier is attached to the first vessel when the adjustable barrier is in the food storing configuration, preferably wherein the adjustable barrier is attached to an outer surface of the first vessel when the adjustable barrier is in the food storing configuration.

55. The container according to claim 41, wherein the adjustable barrier is attached to the second vessel when the adjustable barrier is in the food storing configuration.

56. The container according to claim 41, wherein the adjustable barrier is in the form of a film, and wherein the adjustable barrier is secured in the food storing configuration by an adhesive.

57. A packaged food product comprising a container according to claim 41, wherein the second compartment of the container contains at least one food item, and wherein the first compartment of the container contains a steam source, for example a water-based liquid or a water-based gel, such as an edible sauce or an edible broth.

58. The packaged food product according to claim 57, wherein the second compartment contains a plurality of different food items, optionally wherein at least one food item is contained in the first volume of the second compartment and at least one different type of food item is contained in the second volume of the second compartment when the second compartment comprises a first volume separated from a second volume.

59. A method of packaging a food product, the method comprising inserting at least one food item into the second compartment of a container according to claim 41, wherein the method comprises inserting a steam source into the first compartment of the container, for example wherein the steam source is a water-based liquid or a water-based gel, such as an edible sauce.

60. The method according to claim 59, wherein the method comprises sealing the second compartment from the ambient environment, and optionally sealing the first compartment from the ambient environment.
